(19) United States
(12) Patent Application Publication
(10) Pub. No.: US 2011/0182211 A1
(43) Pub. Date: Jul. 28, 2011

(54) ANONYMOUS COMMUNICATION SYSTEM

(76) Inventors: Natsuko Kagawa, Tokyo (JP); Takeaki Minamizawa, Tokyo (JP)

(21) Appl. No.: 13/056,264

(22) PCT Filed: Jul. 31, 2009
(86) PCT No.: PCT/JP2009/063639

§ 371 Date: Apr. 13, 2011

(30) Foreign Application Priority Data
Jul. 31, 2008 (JP) 2008-197945

(51) Int. Cl. H04L 12/16

(52) U.S. Cl. 370/259

(57) ABSTRACT

Provided is a technique for allowing each of a plurality of communicating parties to determine its own anonymity and/or the other party's anonymity when the communicating parties have established a communication session. Disclosed is an anonymous communication system that is characterized enabling a communication by anonymity, said anonymous communication system detecting anonymities of communication parties during the communication subsequent to establishment of a communication session, and notifying them to communication devices of the communication parties. Disclosed is an anonymous communication method that is characterized enabling a communication by anonymity, said anonymous communication method comprising detecting anonymities of communication parties during the communication subsequent to establishment of a communication session, and notifying them to the communication devices of the communication parties.

### TECHNICAL FIELD

The present invention relates to an anonymous communication system enabling an anonymous communication, and particularly an anonymous communication system that enables a communication party to confirm its own anonymity and an anonymity of a communication partner during the communication.

### BACKGROUND ART

The so-called anonymous communication is a communication to be performed in a situation in which a caller does not reveal identification information for specifying itself to the communication partner. As one example, there exists a caller number notification/non-notification service by an IP communication network using voice described in Non-patent literature 1. In this caller number notification/non-notification service, adopting the caller number non-notification as a default setting at the time of a contract, or affixing “184” to the head of a destination telephone number and dialing up with the caller device, for example, in a telephone network of Japan, instead of making such a setting, makes it possible to make a communication of not notifying a telephone number of a caller device to a callee device, namely, the anonymous communication. Further, adopting the caller number notification as the default setting at the time of a contract, or affixing “186” to the head of a destination telephone number and dialing up with the transmitting side device, for example, in a telephone network of Japan, instead of making such a setting, makes it possible to notify a telephone number of the caller device to the callee device.

Further, the specific number notification service described in Non-patent literature 2 is also one kind of the anonymous communications. In this specific number notification service, when the caller becomes a contractor of the specific number notification service, not a separate telephone number of the caller device but a receiving charge telephone number (one kind of representative numbers) contracted by the caller can be notified to the callee device.

### [Citation List]

### [Non Patent Literature]

[NPL 1] NIPPON TELEGRAM AND TELEPHONE WEST CORPORATION, “IP Communication Network Service Using Voice”, Edition 3.0, Feb. 1, 2007, pp. 11, Number Display (retrieved on Jul. 25, 2008), Internet <URL:http://www.ntt-west.co.jp/flets/hikaridenwa_office/download/hikari_office3.0.pdf>.

[NPL 2] NIPPON TELEGRAM AND TELEPHONE WEST CORPORATION, “Specific Number Notification Service”, (retrieved on Jul. 25, 2008), Internet <URL:http://www.ntt-west.co.jp/flets/hikaridenwa_office/service/bangoutuuchi/index.html>.

[NPL 3] TANIGUCHI Noboru, CHIDA Koji, SHIONOIRI Osamu, and KANAI Atsushi “A Note on Anonymity/Pseudonymity/Identity Management of Decentralized Identity Escrow,” IEICE Technical Report SITE2005-53, the Institute of Electronics, Information and Communication Engineers

[NPL 4] Andreas Pfitzmann and Marit Hansen “Anonymity, Unlinkability, Undetectability, Unobservability, Pseudonymity, and Identity Management—A Consolidated Proposal for Terminology (retrieved on Jul. 25, 2008), Internet <URL:http://dudinf.tu-dresden.de/literatur/Anon_Terminology_v0.31.pdf>.

[NPL 5] The Free Encyclopedia ┌Wikipedia┘, “Anonymity”, (retrieved Jul. 25, 2008), Internet

<URL:http://ja.wikipedia.org/wiki/%E5%8C%BF%E5%90%8D#.E9.96.A2.E9.80.A3.E9.A0.85.E7.9B.AE>

### SUMMARY OF INVENTION

### Technical Problem

In the foregoing anonymous communication systems, a callee can confirm the anonymity of a caller at the time of establishing the communication session. That is, it is only at the time of establishing the communication session that the callee can confirm the anonymity, and a caller or the callee, being a communication party, cannot confirm its own anonymity and the anonymity of the communication partner during the communication subsequent to establishment of the communication session. For this, for example, when the callee forgets to confirm the anonymity of the caller at the time of establishing the communication session, or forgets it due to a long telephone call notwithstanding confirmation thereof, the very callee cannot confirm the anonymity of the caller any longer. Further, with the caller, when he/her does not remember dialing up with “184” affixed, he/her cannot confirm its own anonymity during the communication.

The task to be solved by the present invention is to provide an anonymous communication system that enables the communication party to confirm its own anonymity or the anonymity of the communication partner during the communication.

### Solution to Problem

The first anonymous communication system of the present invention, which is an anonymous communication system enabling the communication by anonymity, detects the anonymities of the communication parties during the communication subsequent to establishment of the communication session, and notifies them to the communication devices of the communication parties.

More specifically, the first anonymous communication system includes an anonymity managing means for retaining anonymity management information including a real address, an anonymous address, and an anonymity of the communication device; an anonymous communication establishing means for acquiring anonymity management information of the caller device and anonymity management information of the callee device from the foregoing anonymity managing means when having received a communication connection request designating the callee device from the caller device, establishing the communication session between the caller device and the cal lee device, and deciding which address, out of the real address and the anonymous address, should be used as an address of the caller device to be notified to the callee device responding to the anonymity of the caller device to be included in the foregoing acquired anonymity management information; and an anonymity notifying means for acquiring the anonymity of at least one of the communication parties of the caller device and the callee device that are performing the communication through the communication session established by the foregoing anonymous communication establishing means from the foregoing anonymity management information, and notifying it to at least one communication device, out of the caller device and the callee device.

Further, the first anonymous communication method of the present invention includes: (a) an anonymous communication establishing step in which an anonymous communication establishing means acquires the anonymity management information of the caller device and the anonymity management information of the callee device from an anonymity managing means for retaining the anonymity management information including a real addresses, an anonymous address, and an anonymity of the communication device when having received a communication connection request designating the callee device from the caller device, establishes the communication session between the caller device and the callee device, and decides which address, out of the real address and the anonymous address, should be used as an address of the caller device to be notified to the callee device responding to the anonymity of the caller device to be included in the foregoing acquired anonymity management information; and (b) an anonymity notifying step in which an anonymity notifying means acquires the anonymity of at least one of the communication parties of the caller device and the callee device that are making the communication through the communication session established by the foregoing anonymous communication establishing step from the foregoing anonymity management information, and notifies it to at least one communication device, out of the caller device and the callee device.

### ADVANTAGEOUS EFFECT OF INVENTION

The present invention enables the communication party to confirm at least one of its own anonymity and the anonymity of the communication partner during the communication subsequent to establishment of the communication session.

### BRIEF DESCRIPTION OF DRAWINGS

FIG. 1 is a block diagram of the anonymous communication system related to a first exemplary embodiment of the present invention.

FIG. 2 is a view illustrating an example of data stored in an anonymity management information storing unit in the first exemplary embodiment of the present invention.

FIG. 3 is a view illustrating one example of data stored in an transmitting/receiving anonymity management information temporally-storing unit in the first exemplary embodiment of the present invention.

FIG. 4 is a view illustrating an example of formats for an anonymity notification request to be used in the first exemplary embodiment of the present invention.

FIG. 5 is an explanatory view of an operation of the anonymous communication system related to the first exemplary embodiment of the present invention.

FIG. 6 is a block diagram of main parts of the communication device in the first exemplary embodiment of the present invention.

FIG. 7 is a block diagram of the anonymous communication system related to a second exemplary embodiment of the present invention.

FIG. 8 is a view illustrating an example of data stored in a notification control information storing unit in the second exemplary embodiment of the present invention.

FIG. 9 is an explanatory view of an operation of the anonymous communication system related to the second exemplary embodiment of the present invention.

FIG. 10 is a view illustrating another example of data stored in the anonymity management information storing unit.

### DESCRIPTION OF EMBODIMENT

### First Exemplary Embodiment

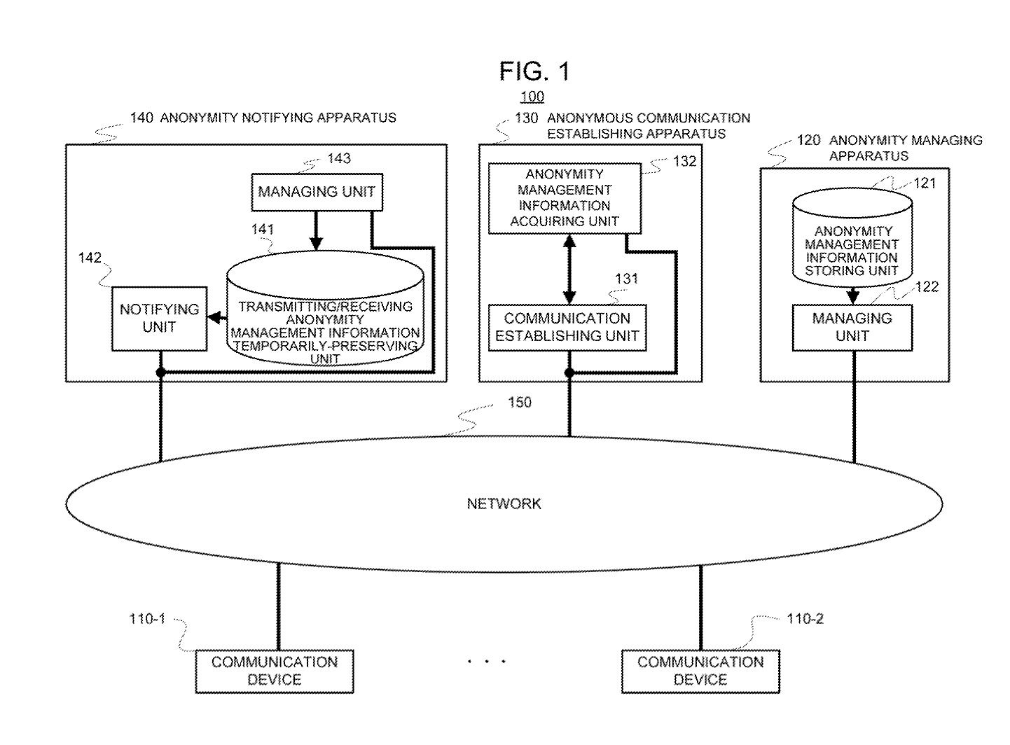

Upon making a reference to FIG. 1, in an anonymous communication system 100 related to the first exemplary embodiment of the present invention, a plurality of communication devices 110, an anonymity managing apparatus 120, anonymous communication establishing apparatus 130, and an anonymity notifying apparatus 140 are communicatably connected via a network 150.

The communication device 110 is a device in use for the anonymous communication, and specifically, an appliance having communication functions such as a mobile telephone machine and a personal computer. Two kinds of communication addresses of the real address and the anonymous address are assigned to each communication device 110.

The real address is an identifier for uniquely identifying the communication device 110, and specifically a separate telephone number, SIP-URI, or the like. A safety of the user might be jeopardized, for example, the user might receive unnecessary communications when the real address becomes known to a malicious third person because the real address is an identifier that the user cannot change easily.

The anonymous address is an identifier that is issued correspondingly to the real address. A correspondence relation between the real address and the anonymous address is managed in the anonymous communication system, and is not opened to the outside including the communication partner at the moment of the anonymous communication. For this, the real address of the user is not revealed from the anonymous address, and the anonymous communication in which a safety of the user is secured is enabled. Further, when the anonymous address becomes known to a malicious third person, annulling or changing the anonymous address makes it possible to secure a safety of the user without changing the real address.

The anonymity managing apparatus 120, which is an apparatus for retaining/managing anonymity management information of the communication device 110, includes an anonymity management information storing unit 121 and a managing unit 122.

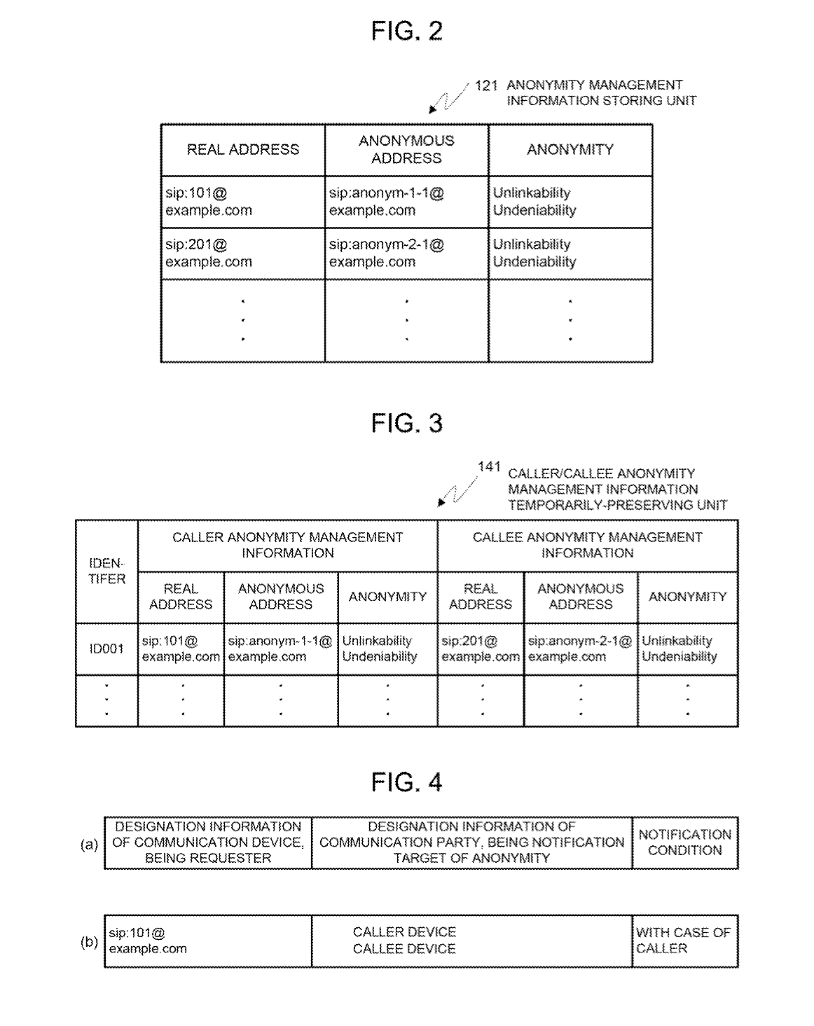

The anonymity management information storing unit 121 is a database for storing the anonymity management information for each communication device 110. The anonymity management information of each communication device 110 is configured of the real address assigned to the above communication device 110, the anonymous address issued correspondingly to this real address, and the anonymity. One example of the anonymity management information stored in the anonymity management information storing unit 121 is shown in FIG. 2.

The anonymity is information indicating at least whether the anonymous address is valid or invalid, and in addition, when the anonymous address is valid, one attribute or more characterizing the anonymity of the anonymous address may be described. As an example of the attribute characterizing the anonymity of the anonymous addreis, three concepts of identity, pseudonymity, and anonymity are defined in the Non-Patent literature 3. Further, six concepts of anonymity, unlinkability, undetectability, unobservability, pseudonymity, and identity are defined in the Non-Patent literature 4. In addition, two concepts of unlinkability and undeniability are defined in the Non-Patent literature 5. By the way, unlinkability refers to the property that who is an actor cannot be determined and besides, whether the actors having done certain two actions are an identical actor cannot be also determined, and undeniability refers to the property that a person cannot show a third party that the actor having done the above action is not me.

The managing section 122 of the anonymity managing apparatus 120 is a means for retrieving the corresponding anonymity management information from the anonymity management information storing unit 121 responding to a request for acquiring the anonymity management information by the anonymous communication establishing apparatus 130, and giving a response to the anonymous communication establishing apparatus 130.

The anonymous communication establishing apparatus 130, which is an apparatus for establishing the communication session between the communication devices 110, includes a communication establishing unit 131 and an anonymity management information acquiring unit 132.

The communication establishing unit 131 is a means for establishing the communication session between the caller device and the callee device when a communication connection request designating the callee device is transmitted from the communication device 110 via the network 150, and further cancelling the established communication session at the time of finishing the communication. The communication establishing unit 131 acquires the anonymity management information of the caller device and the anonymity management information of the callee device from the anonymity managing apparatus 120 through the anonymity management information acquiring unit 132 when establishing the communication session. Further, the communication establishing unit 131 decides which address, out of the real address and the anonymous address, should be used as an address of the caller device to be notified to the callee device responding to the anonymity of the caller device to be included in the acquired anonymity management information. Additionally, in a case where the anonymous addresses are present in a plural number, the communication establishing unit 131 further decides which anonymous address should be notified when having decided to notify the anonymous address.

Further, the communication establishing unit 131, when establishing the communication session, generates transmitting/receiving anonymity management information including the anonymity management information of the caller device as the caller anonymity management information and the anonymity management information of the callee device as the callee anonymity management information each received from the anonymity management information acquiring unit 132, adds a unique identifier to this transmitting/receiving anonymity management information, and transmits it to the anonymity notifying apparatus 140 via the network 150. In addition, the communication establishing unit 131, when cancelling the communication session, transmits an instruction for designating the identifier added to the transmitting/receiving anonymity management information transmitted at the time of establishing the communication session, and cancelling the transmitting/receiving anonymity management information to the anonymity notifying apparatus 140.

The anonymity management information acquiring unit 132 is a means for transmitting a request for acquiring the anonymity management information of the caller device and the anonymity management information of the callee device to the anonymity managing apparatus 120 via the network 150 according to an instruction by the communication establishing unit 131, receiving the anonymity management information to be sent as a response hereto from the anonymity managing apparatus 120, and conveying it to the communication establishing unit 131.

The anonymity notifying apparatus 140, which is an apparatus for notifying the anonymities of the communication parties that make the communication with each other through the communication session established by the anonymous communication establishing apparatus 130 to the communication devices 110, being communication parties, includes an transmitting/receiving anonymity management information temporarily-preserving unit 141, a notifying unit 142, and a managing unit 143.

The transmitting/receiving anonymity management information temporarily-preserving unit 141 is a storing means for temporarily preserving the transmitting/receiving anonymity management information. One example of the transmitting/receiving anonymity management information stored in transmitting/receiving anonymity management information temporarily-preserving unit 141 is shown in FIG. 3.

The managing unit 143 is a means for performing a process of preserving the transmitting/receiving anonymity management information transmitted from the anonymous communication establishing apparatus 130 in the transmitting/receiving anonymity management information temporarily-preserving unit 141. Further, the managing unit 143 performs a process of erasing from the transmitting/receiving anonymity management information temporarily-preserving unit 141 the transmitting/receiving anonymity management information to which an instruction for the erasing has been given by the anonymous communication establishing apparatus 130.

The notifying unit 142 is a means for receiving a request for notifying the anonymity via the network 150 from the communication device 110, and generating a response to this anonymity notification request, and transmitting it to the communication device 110, being a requester.

The anonymity notification request to be transmitted from the communication device 110, as shown in FIG. 4(a), is comprised of information (for example, real address) for designating the communication device 110, being a requester, information for designating the communication party, being a target of notifying the anonymities, and notification conditions. FIG. 4(b) shows a specific example of the anonymity notification requests.

A classification as to the anonymity of the caller device should be notified, the anonymity of the callee device should be notified and the anonymities of both should be notified is set for the information for designating the communication party, being a target of notifying the anonymities.

As the notification condition, for example, “the anonymity is notified only in a case of the anonymous communication that is made in a manner the anonymity of the caller device is such and such”, “the anonymity is notified only in a case of the anonymous communication that is made in a manner the anonymity of the callee device is such and such” “the anonymity is notified only when its own communication device is the caller device”, “the anonymity is notified only when its own communication device is the callee device”, and the like are set.

Additionally, the designation information of the communication party, being a notification target, and notification condition within the anonymity notification request are not essential, and can be omitted. When they have been omitted, how the anonymity and the notification condition that should be notified are set is left to the system setting. How the system is set is arbitrary, and the system settings exemplified below, for example, is thinkable.
(1) The anonymity of the caller device is notified.
(2) The anonymity of the caller device and the anonymous address thereof are notified.
(3) The anonymity of the callee device is notified.
(4) The anonymity of the callee device and the anonymous address thereof are notified.
(5) The anonymities of the caller device and the callee device are notified.
(6) The anonymities of the caller device and the callee device, and the anonymous addresses thereof are notified.

The notifying unit 142 of the anonymity notifying apparatus 140 receives/identifies the anonymity notification request described above, generates a response hereto, and transmits it to the communication device 110, being a requester. Specifically, the notifying unit 142 performs the following process. At first, the notifying unit 142 retrieves the anonymity management information of the caller including the communication device 110 designated as a requester by the anonymity notification request, and the anonymity management information of the callee from the transmitting/receiving anonymity management information temporarily-preserving unit 141. When the notifying unit 142 fails in the retrieval, it transmits, for example, an error to the communication device 110, being a requester. When the notifying unit 142 succeeds in the retrieval, it evaluates the notification condition within the anonymity notification request, and determines whether or not the notification is enabled. When the notifying unit 142 has determined that there is no necessity for the notification, it transmits, for example, a response saying that the notification condition has not held to the communication device 110, being a requester. When the notifying unit 142 has determined that the notification is enabled, it notifies to the communication device 110, being a requester, the anonymity of the communication party that is designated by the designation information of the communication party, being a notification target of the anonymity, within the anonymity notification request, out of the anonymities that are included in the retrieved caller or callee anonymity management information. Additionally, at the moment of notifying the anonymity, the anonymous address having the above anonymity may be notified together therewith.

Next, an exemplary operation of the anonymous communication system 100 related to this exemplary embodiment will be explained. A scheme of transmitting the anonymity notification request to the anonymity notifying apparatus 140 from the communication device 110-1 while the anonymous communication between the communication device 110-1 as a caller device and the communication device 110-2 as a callee device is made is listed as an example. Herein, it is assumed that the user of the communication device 110-1 is A, the real address is sip:101@example.com, the anonymous address is sip:anonym-1-1@example.com, and the anonymity is unlinkability & undeniability, and that the user of the communication device 110-2 is B, the real address is sip:201@example.com, the anonymous address is sip:anonym-2-1@example.com, and the anonymity is unlinkability & undeniability.

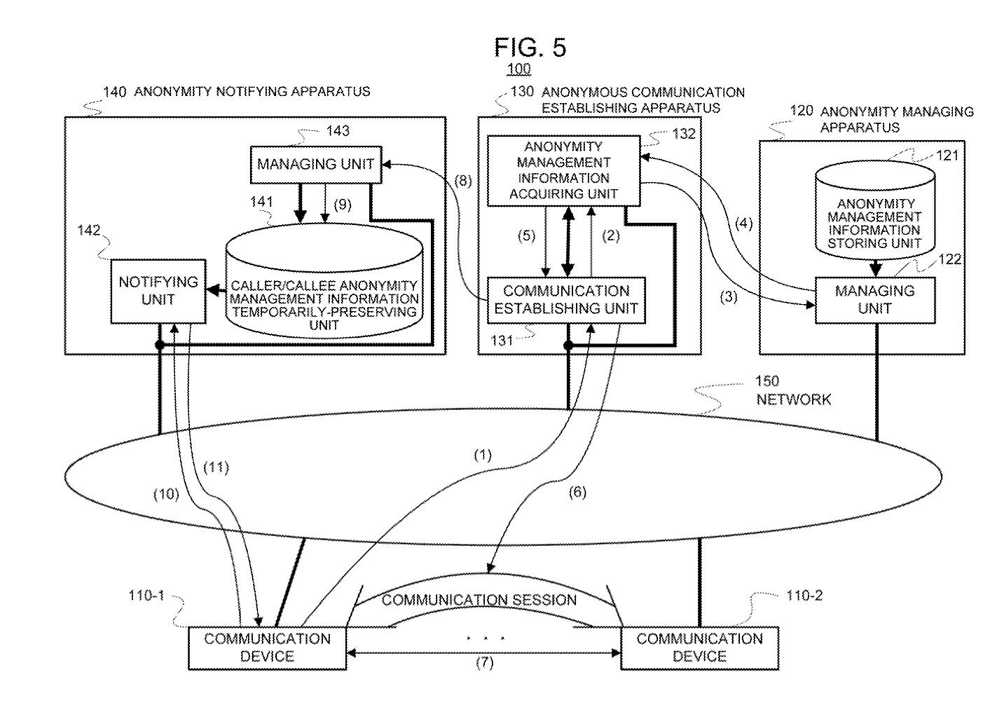

At first, an operation at the moment that the anonymous communication is made between the communication device 110-1 of the user A and the communication device 110-2 of the user B be explained by making a reference to FIG. 5.

When the user A performs a call manipulation to the user B over the communication device 110-1, a communication connection request is transmitted to the communication establishing unit 131 of the anonymous communication establishing apparatus 130 via the network 150 from the communication device 110-1 ((1) of FIG. 5). In this communication connection request, for example, the real address of the communication device 110-1 is included as information for specifying the communication device 110-1, being a caller device, and for example, the anonymous address of the communication device 110-2 is included as information for specifying the communication device 110-2, being a callee device.

The communication establishing unit 131 delivers the real address of the caller device and the anonymous address of the callee device that are included in the communication connection request to the anonymity management information acquiring unit 132, and makes a request for acquiring the caller anonymity management information and the callee anonymity management information ((2) of FIG. 5).

The anonymity management information acquiring unit 132 transmits a request for acquiring the anonymity management information including the real address of the caller device and a request for acquiring the anonymity management information including the anonymous address of the callee device to the managing unit 122 of the anonymity managing apparatus 120 via the network 150 ((3) of FIG. 5).

The managing unit 122 retrieves the anonymity management information including a real address identical to that of the caller device, and the anonymity management information including an anonymous address identical to that of the callee device from the anonymity management information storing unit 121, and transmits the discovered anonymity management information to the anonymity management information acquiring unit 132 via the network 150 ((4) of FIG. 5). The anonymity management information acquiring unit 132 conveys the received anonymity management information to the communication establishing unit 131 ((5) of FIG. 5). As a result, it follows that the anonymity management information of the first line shown in FIG. 2 and the anonymity management information of the second line shown in FIG. 2 are delivered as the caller anonymity management information and the callee anonymity management information, respectively, to the communication establishing unit 131.

The communication establishing unit 131 confirms that the anonymity within the caller anonymity management information is unlinkability & undeniability, and decides to use the anonymous address as an address of the caller device that is notified to the callee device. And, the communication establishing unit 131 reads out the real address of the communication device 110-2, being a callee device, from the callee anonymity management information, conceals the real address of the communication device 110-1, being a caller device, from the communication device 110-2, being a callee device, notifies the anonymous address within the caller anonymity management information instead thereof, and establishes the communication session between the communication device 110-1 and the communication device 110-2 ((6) of FIG. 5). This allows the communication device 110-1 and the communication device 110-2 to start the communication through the above communication session ((7) of FIG. 5).

Simultaneously therewith, the communication establishing unit 131 transmits the transmitting/receiving anonymity management information including the caller anonymity management information and the callee anonymity management information to the managing unit 143 of the anonymity notifying apparatus 140 via the network 150 ((8) of FIG. 5). The managing unit 143 registers the received transmitting/receiving anonymity management information into the transmitting/receiving anonymity management information temporarily-preserving unit 141 ((9) of FIG. 5). This allows the transmitting/receiving anonymity management information shown in the first line of FIG. 3 to be registered into transmitting/receiving anonymity management information temporarily-preserving unit 141.

Next, an operation at the moment that the user A transmits the anonymity notification request from the communication device 110-1 while the anonymous communication is being made between the communication device 110-1 and the communication device 110-2 will be explained.

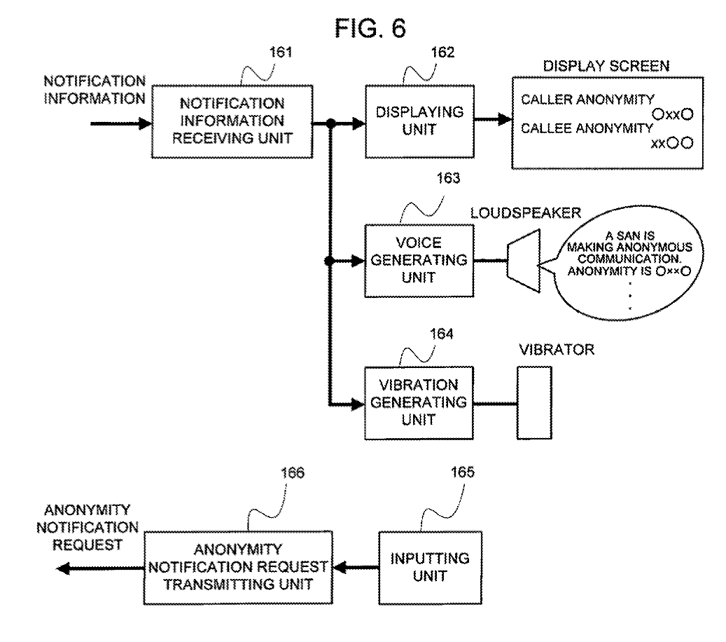

Upon making a reference to FIG. 6, an inputting unit 165 such as a keyboard and an anonymity notification request transmitting unit 166 are installed in the communication device 110-1. When the user A inputs the real address of its own device, the notification target of the anonymity and the notification condition from the inputting unit 165 so that the user is notified of the anonymity of the communication party of the anonymous communication that is being made in the communication device 110-1, the anonymity notification request transmitting unit 166 generates the anonymity notification request shown in FIG. 4(b) from the inputted information, and transmits it to the notifying unit 142 of the anonymity notifying apparatus 140 via the network 150 ((10) of FIG. 5).

The notifying unit 142 of the anonymity notifying apparatus 140, upon receipt of the anonymity notification request via the network 150 from the communication device 110-1, retrieves the caller anonymity management information including a real address identical to that of the communication device 110-1, being a requester, and the callee anonymity management information within the anonymity notification request from the transmitting/receiving anonymity management information temporarily-preserving unit 141. In a case of the anonymity notification request of FIG. 4(b), the caller anonymity management information shown in the first line of FIG. 3 is retrieved because the real address of the communication device 110-1, being a requester, is sip:101@example.com. Next, the notifying unit 142 evaluates the notification condition within the anonymity notification request, and determines whether or not the notification is enabled. In a case of the anonymity notification request of FIG. 4(b), the notification condition is “the case of the caller”, and this time condition that the communication device 110-1 is the origination side is matched to the above the notification condition, whereby the notifying unit 142 determines that the notification is enabled. Next, the notifying unit 142 notifies the anonymity of the communication party that is designated by the designation information of the communication party, being a notification target of the anonymity, within the anonymity notification request to the communication device 110-1 that is specified by the designation information of the communication device, being a the requester, within the anonymity notification request ((11) of FIG. 5). In a case of the anonymity notification request of FIG. 4(b), the designation information of the communication party, being a notification target of the anonymity, points to the caller device and the callee device, whereby the notification information saying that the anonymity within the foregoing retrieved caller anonymity management information is the anonymity of the caller device, and the anonymity within the callee anonymity management information corresponding to this caller anonymity management information is the anonymity of the callee device is transmitted. The anonymous address of the caller device and the anonymous address of the callee device at this moment may be incorporated into the notification information for transmission.

The communication device 110-1, upon receipt of the notification information, presents the notification information to the user A. As a method of presenting the notification information, any of the method of displaying on the display screen, the method of outputting in a voice or sound form, and the method of outputting in a vibration form may be used, and a combination thereof may be used. One example of a configuration of presenting the notification information is shown in FIG. 6. In this example, a notification information receiving unit 161 receives the notification information from the notifying unit 142, and conveys it to a displaying unit 162, a voice generating unit 163 and a vibration generating unit 164. The displaying unit 162 displays the anonymities of the caller device and the callee device notified by the notification information on the displaying screen such as a liquid crystal display. Further, the voice generating unit 163 outputs the similar content in a voice form from the voice output element such as a loudspeaker. In addition, the vibration generating unit 164 notifies the anonymity to the user A by vibrating a vibrator with a vibration pattern caused to correspond to each anonymity on a one-to-one basis.

Thereafter, after the communication between the communication device 110-1 and the communication device 110-2 is finished, the communication establishing unit 131 of the anonymous communication establishing apparatus 130 releases the communication session established between the communication device 110-1 and the communication device 110-2. Further, the communication establishing unit 131 designates the identifier of the transmitting/receiving anonymity management information transmitted to the anonymity notifying apparatus 140 at the time of establishing this communication session, and requests the managing unit 143 of the anonymity notifying apparatus 140 via the network 150 to delete the transmitting/receiving anonymity management information. The managing unit 143, in response to this request, deletes the corresponding transmitting/receiving anonymity management information from the transmitting/receiving anonymity management information temporarily-preserving unit 141. For this, a response of an error is returned even though the anonymity notification request is issued from the communication device 110-1 and the communication device 110-2 to the anonymity notifying apparatus 140 because the corresponding anonymity management information of the caller or the callee is not preserved in the transmitting/receiving anonymity management information temporarily-preserving unit 141.

Next, an erect of this exemplary embodiment will be explained.

This exemplary embodiment enables the communication party to confirm its own anonymity and the anonymity of the communication partner during the communication subsequent to establishment of the communication session.

Further, according to this exemplary embodiment, the communication party itself can control the timing in which the notification is received because the anonymity of the communication party is notified in a form of making a response to the anonymity notification request transmitted by the communication party.

Further, this exemplary embodiment makes it possible to freely select the reception of a notification of only the anonymity of the caller device, the reception of a notification of only the anonymity of the callee device, and the reception of a notification of the anonymities of both when the anonymous communication is started with a certain communication device as a caller device and another communication device as a callee device because the communication party, being a notification target of the anonymity, can be designated by the anonymity notification request.

Further, according to this exemplary embodiment, previously setting arbitrary notification conditions such as “a condition that only the previously-set anonymity is notified”, “a condition that the anonymity is notified when its own communication device is the caller device”, and “a condition that the anonymity is notified when its own communication device is the callee device” makes it possible to receive only a desired notification because the notification condition can be designated by the anonymity notification request.

### Second Exemplary Embodiment

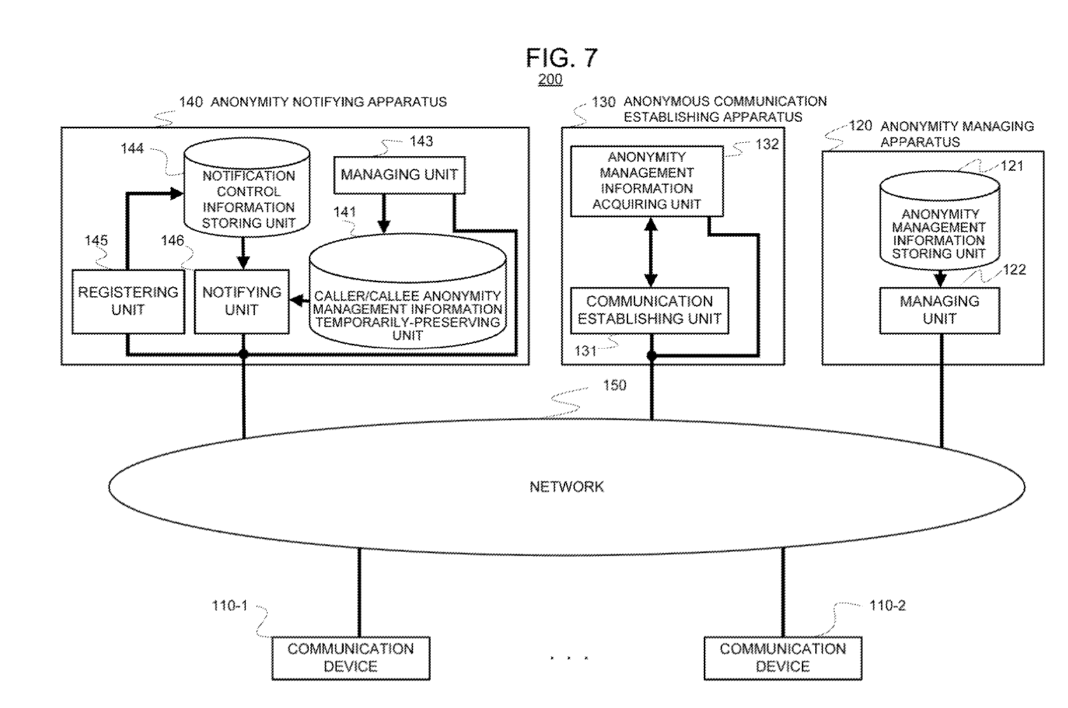

Upon making a reference to FIG. 7, an anonymous communication system 200 related to the second exemplary embodiment of the present invention differs in a point of including a notification control information storing unit 144 and a registering unit 145 within the anonymity notifying apparatus 140, and in a point of including a notifying unit 146 instead of the notifying unit 142 as compared with the anonymous communication system 100 related to the first exemplary embodiment shown in FIG. 1, and is identical in other points to the anonymous communication system 100 related to the first exemplary embodiment.

The notification control information storing unit 144 is a storing means for storing notification control information for deciding the communication devices to which the anonymities are notified. Specifically, the notification control information is composed of the designation information (for example, the real address) of the communication device 110, being a notification target, the designation information of the communication party, being a notification target of the anonymity, and the notification conditions.

For example, when a certain user desires to receive a notification of its own anonymity and the anonymity of the communication partner at the moment of making the anonymous communication using its own mobile telephone machine, the real address of the above mobile telephone machine, for example, is set to the designation information of the communication device 110, being a notification target.

A classification as to the anonymity of the caller device should be notified, the anonymity of the callee device should be notified, and the anonymities of both should be notified is set to the designation information of the communication party, being a notification target of the anonymity.

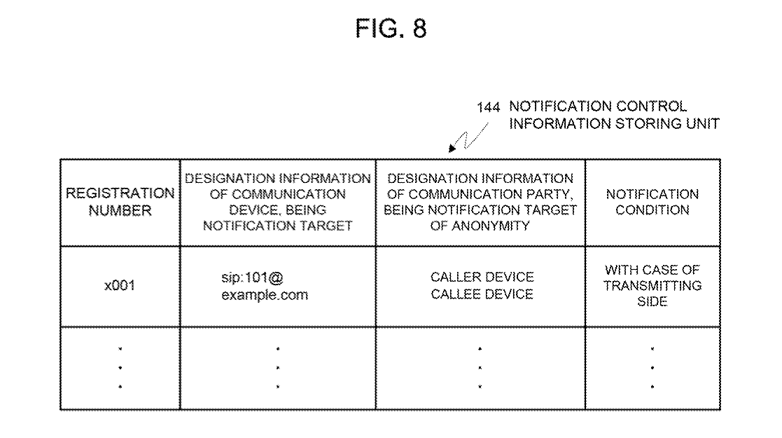

For example, “a condition that the anonymity is notified at the time of establishing the communication session”, “a condition that the anonymity is notified after t seconds elapse since a start of the communication”, “a condition that only the pre-set anonymity is notified”, “a condition that the anonymity is notified only when the communication is made within a pre-set time zone”, “a condition that the anonymity is notified only when the communication device, being a notification target, is the caller device”, “a condition that the anonymity is notified only when the communication device, being a notification target, is the callee device” and the like are set to the notification condition. One example of the notification control information stored in the notification control information storing unit 144 is shown in FIG. 8.

Additionally, the notification target of the anonymity and the notification condition within notification control information are not essential, and can be omitted. When they have been omitted, how the anonymity and the notification condition that should be notified are set is left to the system setting. How the system is set is arbitrary, and the system settings exemplified below, for example, is thinkable.
(1) The anonymity of the caller device is notified.
(2) The anonymity of the caller device and the anonymous address thereof are notified.
(3) The anonymity of the callee device is notified.
(4) The anonymity of the callee device and the anonymous address thereof are notified.
(5) The anonymities of the caller device and the callee device are notified.
(6) The anonymities of the caller device and the callee device, and the anonymous addresses thereof are notified.
(7) The timing is set in such a manner that whether or not to make the above-mentioned notifications (1) to (6) is determined after a lapse oft seconds since a start of the communication.

The registering unit 145 is a means for registering the notification control information into the notification control information storing unit 144. The registering unit 145 receives a registration request via the network 150 from the communication device 110 and the device such as a personal computer not shown in the figure, affixes a registration number to the notification control information attached to the above registration request, and registers it into the notification control information storing unit 144. Further, when the registering unit 145 receives a deletion request via the network 150 from the communication device 110 and the device such as a personal computer not shown in the figure, it performs a process of deleting the notification control information designated by the deletion request from the notification control information storing unit 144.

The notifying unit 146 is a means for determining a necessity for notifying the anonymities of the communication parties during a time ranging from the registration of the new transmitting/receiving anonymity management information related to the communication between the communication devices 110 into the transmitting/receiving anonymity management information temporarily-preserving unit 141 up to the deletion thereof, namely, during a period that the established communication session is active, and notifying them to the communication device 110, being a notification target, if necessary.

Specifically, the notifying unit 146 pays attention to the caller anonymity management information to be included in the transmitting/receiving anonymity management information, and performs the following process. At first, the notifying unit 146 retrieves the notification control information within the caller anonymity management information, which defines the communication device to be specified by the real address as a notification target, from the notification control information storing unit 144. When the notifying unit 146 fails in the retrieval, it finishes the process as to the caller anonymity management information. When the notifying unit 146 succeeds in the retrieval, it evaluates the notification condition to be included in the retrieved notification control information, and determines whether or not the notification is enabled. When the notifying unit 146 has determined that there is no necessity for the notification, it finishes the process as to the caller anonymity management information. When the notifying unit 146 has determined that the notification is enabled, it notifies the anonymity of the communication party designated by the designation information of the communication party, being a notification target of the anonymity, that is included in the retrieved notification control information, out of the anonymities within the caller anonymity management information and the callee anonymity management information, to the communication device 110, being a notification target, which is designated by the retrieved notification control information. With this, the notifying unit 146 finishes the process paying attention to the caller anonymity management information, next pays attention to the callee anonymity management information, and repeats a process similar to the process paying attention to the caller anonymity management information. Additionally, at the moment of notifying the anonymity, the anonymous address having the above anonymity may be notified together therewith.

Next, an exemplary operation of the anonymous communication system 200 related to this exemplary embodiment will be explained. A scheme of notifying the anonymities of the communication parties to the communication device 110-1 while the communication device 110-1 makes communication with the communication device 110-2 is listed as an example.

Herein, similarly to an example of the first exemplary embodiment, it is assumed that the user of the communication device 110-1 is A, the real address is sip:101@example.com, the anonymous address is sip:anonym-1-1@example.com, and the anonymity is unlinkability & undeniability, and that the user of the communication device 110-2 is B, the real address is sip:201@example.com, the anonymous address is sip:anonym-2-1@example.com, and the anonymity is unlinkability & undeniability.

The user X registers the notification control information into the anonymity notifying apparatus 140 so that when the anonymous communication is made in the communication device 110-1, this communication device 110-1 is notified of the anonymities of the communication parties. This registration is enabled, for example, by making access to the registering unit 145 of the anonymity notifying apparatus 140 from the communication device 110-1, and inputting necessary information. While the registering manipulation was performed from the communication device 110-1 herein, the registering manipulation can be also performed from other devices such as personal computer. With this registering manipulation, it is assumed that the notification control information of a registration number X001 of FIG. 8 has been registered into the notification control information storing unit 144 of the anonymity notifying apparatus 140. Additionally, the registering unit 145 may authenticate registers to exclude the registration by unjustified registers at the moment of registering the notification control information.

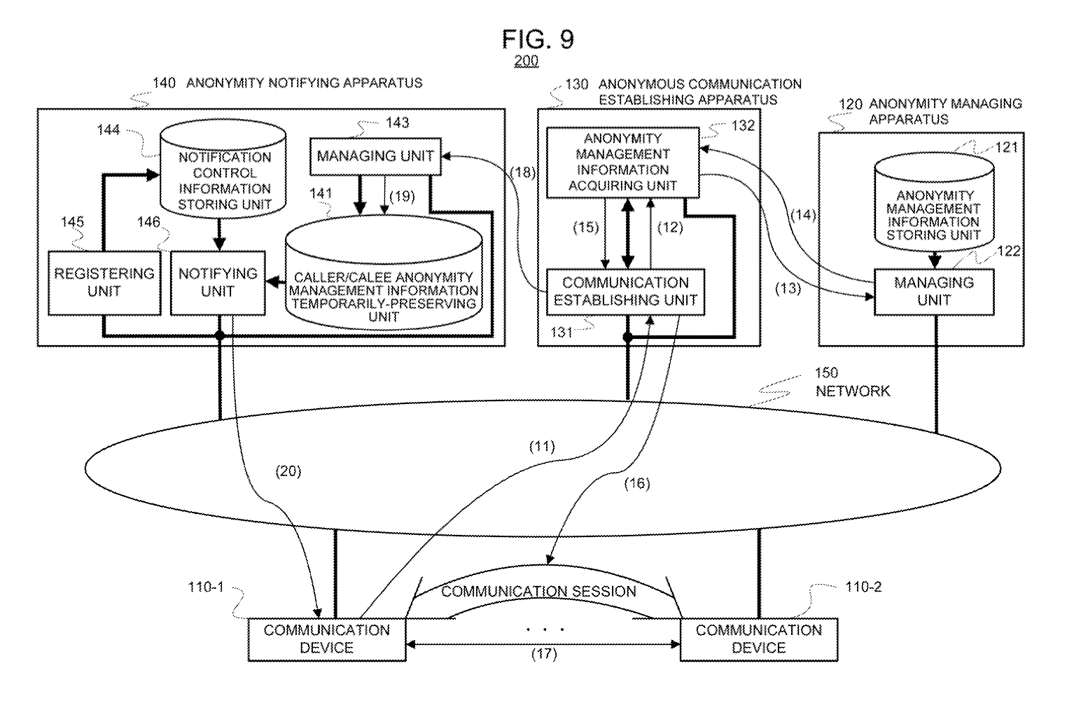

Continuously, an operation at the moment that the user A makes the anonymous communication with the communication device 110-2 of the user B from the communication device 110-1 will be explained by making reference to FIG. 9.

When the user A performs a call manipulation to the user B over the communication device 110-1, a communication connection request is transmitted to the communication establishing unit 131 of the anonymous communication establishing apparatus 130 via the network 150 from the communication device 110-1 ((11) of FIG. 9). In this communication connection request, for example, the real address of the communication device 110-1 is included as information for specifying the communication device 110-1, being a caller device, and for example, the anonymous address of the communication device 110-2 is included as information for specifying the communication device 110-2, being a callee device.

The communication establishing unit 131 delivers the real address of the caller device and the anonymous address of the callee device that are included in the communication connection request to the anonymity management information acquiring unit 132, and makes a request for acquiring the caller anonymity management information and the callee anonymity management information ((12) of FIG. 9).

The anonymity management information acquiring unit 132 transmits a request for acquiring the anonymity management information including the real address of the caller device and a request for acquiring the anonymity management information including the anonymous address of the callee device to the managing unit 122 of the anonymity managing apparatus 120 via the network 150 ((13) of FIG. 9).

The managing unit 122 retrieves the anonymity management information including a real address identical to that of the caller device, and the anonymity management information including an anonymous address identical to that of the callee device from the anonymity management information storing unit 121, and transmits the discovered anonymity management information to the anonymity management information acquiring unit 132 via the network 150 ((14) of FIG. 9). The anonymity management information acquiring unit 132 conveys the received anonymity management information to the communication establishing unit 131 ((15) of FIG. 9). As a result, it follows that the anonymity management information of the first line shown in FIG. 2, and the anonymity management information of the second line shown in FIG. 2 are delivered as the caller anonymity management information and the callee anonymity management information, respectively, to the communication establishing unit 131.

The communication establishing unit 131 confirms that the anonymity within the caller anonymity management information is unlinkability & undeniability, and decides to use the anonymous address as an address of the caller device that is notified to the callee device. And, the communication establishing unit 131 reads out the real address of the communication device 110-2, being a callee device, from the callee anonymity management information, conceals the real address of the communication device 110-1, being a caller device, from the communication device 110-2, being a callee device, notifies the anonymous address within the caller anonymity management information instead thereof, and establishes the communication session between the communication device 110-1 and the communication device 110-2 ((16) of FIG. 9). This allows the communication device 110-1 and the communication device 110-2 to start the communication through the above communication session ((17) of FIG. 9).

Simultaneously therewith, the communication establishing unit 131 transmits the transmitting/receiving anonymity management information including the caller anonymity management information and the callee anonymity management information to the managing unit 143 of the anonymity notifying apparatus 140 via the network 150 ((18) of FIG. 9). The managing unit 143 registers the received transmitting/receiving anonymity management information into the transmitting/receiving anonymity management information temporarily-preserving unit 141 ((19) of FIG. 9). This allows the transmitting/receiving anonymity management information shown in the first line of FIG. 3 to be registered into transmitting/receiving anonymity management information temporarily-preserving unit 141.

The operation so far is identical to that of the first embodiment explained by making a reference FIG. 5.

The notifying unit 146 of the anonymity notifying apparatus 140 firstly pays attention to the caller anonymity management information, out of the transmitting/receiving anonymity management information newly registered into the transmitting/receiving anonymity management information temporarily-preserving unit 141. When the notifying unit 146 retrieves the notification control information that includes the real address within this caller anonymity management information as the real address of the communication device, being a notification target, from the notification control information storing unit 144, it obtains the notification control information of the first line of FIG. 8, whereby it evaluates the notification condition to be included in the above notification control information, and determines whether or not the notification is enabled. The notification condition of the notification control information described in the first line of FIG. 8, which is “the case of the caller”, meets this-time condition that the communication device 110-1 is the caller device, whereby the notifying unit 146 determines that the notification is enabled. And, the notifying unit 146 transmits the notification information including the anonymity of the communication party designated as a communication party, being a notification target of the anonymity, by the retrieved notification control information to the communication device 110-1 designated as a communication device of the notification target in the notification control information ((20) of FIG. 9). In this case, the notification information having the anonymity within the caller anonymity management information taken as the anonymity of the caller device, and the anonymity within the callee anonymity management information taken as the anonymity of the callee device is transmitted because the notification target of the anonymity is the caller device and the callee device. At this time, the anonymous address of the caller device and the anonymous address of the callee device may be incorporated into the notification information for transmission.

The communication device 110-1, upon receipt of the notification information by the notification information receiving unit 161 shown in FIG. 6, presents the notification information to the user A by displaying it on the display screen by the displaying unit 162, outputting it in a sound form by the voice generating unit 163, and notifying it in a vibration form by the vibration generating unit 164.

Thereafter, after the communication between the communication device 110-1 and the communication device 110-2 is finished, the communication establishing unit 131 of the anonymous communication establishing apparatus 130 releases the communication session established between the communication device 110-1 and the communication device 110-2. Further, the communication establishing unit 131 designates the identifier of the transmitting/receiving anonymity management information transmitted to the anonymity notifying apparatus 140 at the time of establishing this communication session, and requests the managing unit 143 of the anonymity notifying apparatus 140 via the network 150 to delete the transmitting/receiving anonymity management information. The managing unit 143, in response to this request, deletes the corresponding transmitting/receiving anonymity management information from the transmitting/receiving anonymity management information temporarily-preserving unit 141.

Next, an effect of this exemplary embodiment will be explained.

This exemplary embodiment enables the communication party to confirm its own anonymity and the anonymity of the communication partner during the communication subsequent to establishment of the communication session.

Further, this exemplary embodiment makes it possible to freely select the reception of a notification of only the anonymity of the caller device, the reception of a notification of only the anonymity of the callee device, and the reception of a notification of the anonymities of both when the anonymous communication is started with a certain communication device as a caller device and another communication device as a callee device because the communication party, being a notification target of the anonymity, can be designated by the notification control information that is previously registered.

Further, according to this exemplary embodiment, previously setting arbitrary notification conditions such as “a condition that the anonymity is notified after a lapse of t seconds since a start of the communication”, “a condition that only the previously-set anonymity is notified”, “a condition that the anonymity is notified when its own communication device is the caller device”, and “a condition that the anonymity is notified when its own communication device is the callee device” makes it possible to receive only a desired notification at a desired timing because the notification condition can be designated by the notification control information that is previously registered.

### Other Exemplary Embodiments

The present invention is not limited to the exemplary embodiments mentioned above, and the following various additions/modifications hereto are enabled.

While the explanation was made in the exemplary embodiments mentioned above on the assumption that the anonymous addrgss corresponding to the real address of the communication device was pre-generated and stored in the anonymity managing apparatus 120, it may be dynamically generated. In this case, for example, a function of generating the anonymous address from the real address of the communication device is installed into the managing unit 122 of the anonymity managing apparatus 120. When having received a request for acquiring the anonymity management information including the real address from the anonymity management information acquiring unit 132 of the anonymous communication establishing apparatus 130, the managing unit 122 generates the anonymous address having a desired anonymity from the received real address, registers the anonymity management information, which is configured of the real address, the foregoing generated anonymous address, and the anonymity, to the anonymity management information storing unit 121, and simultaneously therewith, transmits it to the anonymity management information acquiring unit 132 in a case where the corresponding anonymity management information does not exist in the anonymity management information storing unit 121, or in a case where the anonymous address different from the previous one needs to be generated even though the corresponding anonymity management information exists because the anonymity is, for example, unlinkability.

While the explanation was made in the exemplary embodiments mentioned above on the assumption that the anonymity management information of all of the communication devices was managed by one anonymity managing apparatus 120, they may be dispersedly managed by a plurality of the anonymity managing apparatuses 120.

While one anonymous communication establishing apparatus 130 recognized the real address of the caller communication device and the real address of the callee communication device, and established the communication session between both of the communication devices in the exemplary embodiments mentioned above, a plurality of the anonymous communication establishing apparatuses may sharedly establish the communication session so that the real addresses of both of the caller and the callee do not become known to one anonymous communication establishing apparatus. Specifically, a first anonymous communication establishing apparatus having received the communication connection request including the real address of the caller and the anonymous address of the callee from the communication device of the caller establishes the communication session with the communication device that is specified with the real address of the caller, and transmits the anonymous address of the communication device of the callee, and the anonymous address of the caller within the anonymity management information of the caller acquired from the anonymity managing apparatus to a second anonymous communication establishing apparatus. The second anonymous communication establishing apparatus acquires the anonymity management information including the real address corresponding to the anonymous address of the callee from the anonymity managing apparatus, and establishes the communication session with the communication device that is specified with the real address of the callee. Finally, the communication session established by the first anonymous communication establishing apparatus, and the communication session established by the second anonymous communication establishing apparatus are linked, and the communication session in use for the communication between the caller and the callee is generated.

While the explanation was made in the exemplary embodiments mentioned above on the assumption that the anonymity notifying apparatus 140 was an apparatus physically different from the anonymous communication establishing apparatus 130, they may be mounted into an identical computer. In this case, the communication between the anonymous communication establishing apparatus 130 and the anonymity notifying apparatus 140 may be made with an interprocess communication within the computer.

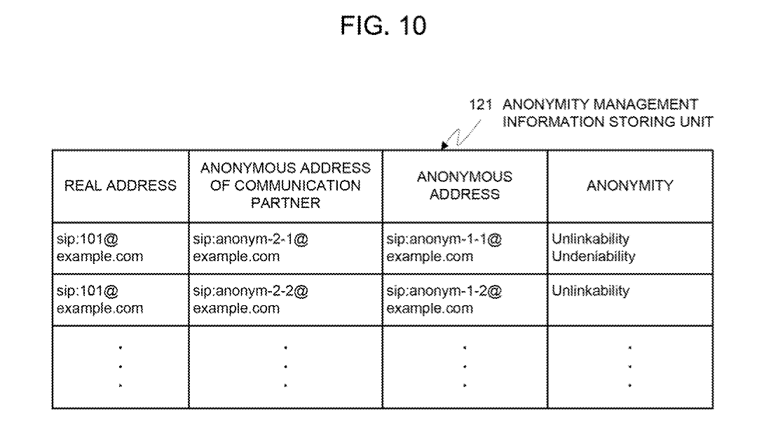

While the explanation was made in the exemplary embodiments mentioned above on the assumption that the anonymous address of the communication device corresponded to the real address on a one-to-one basis, a plurality of the anonymous addresses may correspond to one real address. In this case, all of the anonymities may coincide with each other, and the anonymities may differ from each other partially or completely. Further, the anonymous addresses may be used properly according to the anonymous address of the communication partner. FIG. 10 shows an example of the anonymity management information in which two anonymous addresses of sip:anonym-1-1@example.com and sip:anonym-1-2@example.com correspond to the communication device having sip:101@example.com as a real address. In this example, the setting is made so that sip:anonym-1-1@example.com is used when the anonymous address of the communication partner is sip:anonym-2-1@example.com, and sip:anonym-1-2@example.com is used when the anonymous address of the communication partner is sip:anonym-2-2@example.com. In a case of using such anonymity management information, for example, when making a request for acquiring the anonymity management information including the real address of the communication device of the caller, the anonymous communication establishing apparatus 130 designates the anonymous address (for example, it is assumed that the anonymous address is sip:anonym-2-1@example.com) as well of the callee, being a communication partner, during the request. The managing unit 122 of the anonymity managing apparatus 120 retrieves the anonymity management information having the real address sip:101@example.com of the caller designated by the acquirement request, and yet having the anonymous address of the communication partner (callee) designated during the request from the anonymity management information storing unit 121. Thus, with the case of FIG. 10, the anonymity management information of the first line is retrieved and sent to the anonymous communication establishing apparatus 130.

While the explanation was made in the exemplary embodiments mentioned above on the assumption that it is with only the other one communication device that one communication device simultaneously made the anonymous communication, it is also possible for one communication device to simultaneously make the anonymous communications with a plurality of the other communication devices. At that moment, as shown in FIG. 10, the different anonymous address may be used for each communication partner. At this time, when the above one communication device becomes a device of the notification target, for all of the anonymous communications that the above one communication device is currently making, the anonymities of the above communication parties (either the caller or the callee, or both thereof) may be notified.

While the explanation was made in the exemplary embodiments mentioned above on the assumption that one communication device made one anonymous communication only with the other one communication device, it is also possible for one communication device to simultaneously establish a plurality of the communication sessions with the other one communication device, and to simultaneously make a plurality of the anonymous communications by using the anonymous addresses each having the identical anonymity, or the anonymous addresses each having the different anonymity for each anonymous communication. At this time, when the above one communication device becomes a device of the notification target, for all of the anonymous communications that the above one communication device is currently making with the other one communication device, the anonymity of either the above caller or the above callee, or the anonymities of both may be notified to the devices of the communication parties. At this time, the anonymous addresses in use for individual anonymous communications, and session identifiers, which are given to respective communication sessions by the anonymous communication establishing apparatus 130 in order to identify individual anonymous communications, may be notified together therewith. Further, when the above one communication device designates the session identifier, and issues the anonymity notification request, the anonymity of either the above caller or the above callee, or the anonymities of both may be notified for the communication specified by the session identifier, out of all of the anonymous communications that the above one communication device is currently making with the other one communication device.

Further, while, needless to say, each function that the anonymous communication establishing apparatus, the anonymity managing apparatus, the anonymity notifying apparatus and the communication device of each of the foregoing embodiments have can be realized in a hardware manner, it can be realized with a computer and a program.

In the system of the anonymous communication that is made between the communication devices such as the mobile telephone machines via Internet and Next Generation Network (NGN), the present invention is applicable to the system in which the communication party confirms its own anonymity and the anonymity of the communication partner during the communication subsequent to establishment of the communication session, and the method thereof.

As mentioned above, a first aspect of the present invention, which is an anonymous communication system enabling a communication by anonymity, is characterized in detecting anonymities of communication parties during a communication subsequent to establishment of a communication session, and notifying them to communication devices of the communication parties.

A second aspect of the present invention is characterized in, in the above-mentioned aspect, including: an anonymity managing means for retaining anonymity management information including a real address, an anonymous address and an anonymity of the communication device; an anonymous communication establishing means for acquiring the anonymity management information of a caller device and the anonymity management information of a callee device from the foregoing anonymity managing means when having received a communication connection request designating the callee device from the caller device, establishing the communication session between the caller device and the callee device, and deciding which address, out of the real address and the anonymous address, should be used as an address of the caller device to be notified to the callee device responding to the anonymity of the caller device to be included in the foregoing acquired anonymity management information; and an anonymity notifying means for acquiring the anonymity of at least one of the communication parties of the caller device and the callee device that are performing the communication through the communication session established by the foregoing anonymous communication establishing means from the foregoing anonymity management information, and notifying it to at least one communication device, out of the caller device and the callee device.

A third aspect of the present invention is characterized in, in the above-mentioned aspect, including an transmitting/receiving anonymity management information temporarily-preserving means for preserving the forgoing anonymity management information acquired by the foregoing anonymous communication establishing means during a period that the communication session established between the caller device and the callee device is active, wherein the foregoing anonymity notifying means acquires the anonymity of at least one of the communication parties of the caller device and the callee device, from the foregoing anonymity management information stored in the foregoing transmitting/receiving anonymity management information temporarily-preserving means.

A fourth aspect of the present invention is characterized in that, in the above-mentioned aspect, the foregoing anonymity notifying means receives an anonymity notification request for requesting a notification of the anonymity of at least one device, out of the caller device and the callee device, from at least one device, out of the caller device and the callee device that are performing the communication through the communication session established by the foregoing anonymous communication establishing means, acquires the anonymity requested by the above anonymity notification request from the foregoing anonymity management information, and notifies it to the communication device, being a requester.

A fifth aspect of the present invention is characterized in that in the above-mentioned aspect, the foregoing anonymity notification request includes designation information of the communication device, being a requester, and notification conditions, and that the foregoing anonymity notifying means detects an anonymous communication in which the communication device to be designated by the foregoing designation information of the communication device, being a requester, participates as the caller device or the callee device, out of the anonymous communications that are being made through the communication session to be established by the foregoing anonymous communication establishing means, determines whether or not the above detected anonymous communication satisfies the notification condition within the foregoing anonymity notification request, acquires the anonymity of at least one of the communication parties of the caller device and the callee device in the foregoing detected anonymous communication from the foregoing anonymity management information when it satisfies the notification condition, and notifies it to the foregoing communication device, being a requester.

A sixth aspect of the present invention is characterized in that in the above-mentioned aspect, the foregoing anonymity notification request includes designation information of the communication device, being a requester, and designation information of the communication party, being a notification target of the anonymity, and that the foregoing anonymity notifying means detects an anonymous communication in which the communication device to be designated by the foregoing designation information of the communication device, being a requester, participates as the caller device or the callee device, out of the anonymous communications that are being performed through the communication session to be established by the foregoing anonymous communication establishing means, acquires the anonymity of the communication party to be designated by the designation information of the communication party, being a notification target of the anonymity, within the foregoing anonymity notification request, out of the communication parties of the caller device and the callee device in the above detected anonymous communication, from the foregoing anonymity management information, and notifies it to the foregoing communication device, being a requester.

A seventh aspect of the present invention is characterized in that in the above-mentioned aspect, the foregoing anonymity notification request includes designation information of the communication device, being a requester, designation information of the communication party, being a notification target of the anonymity, and notification conditions, and that the foregoing anonymity notifying means detects an anonymous communication in which the communication device to be designated by the foregoing designation information of the communication device, being a requester, participates as the caller device or the callee device, out of the anonymous communications that are being performed through the communication session to be established by the foregoing anonymous communication establishing means, determines whether or not the above detected anonymous communication satisfies the notification condition within the foregoing anonymity notification request, acquires the anonymity of the communication party to be designated by the designation information of the communication party, being a notification target of the anonymity, within the foregoing anonymity notification request, out of the communication parties of the caller device and the callee device in the foregoing detected anonymous communication, from the foregoing anonymity management information when it satisfies the notification condition, and notifies it to the foregoing communication device, being a requester.

An eighth aspect of the present invention is characterized in, in the above-mentioned aspect, including a notification control information storing means for storing notification control information including designation information of the communication device, being a notification target, wherein the foregoing anonymity notifying means retrieves the notification control information, which designates the communication device for performing the communication through the communication session to be established by the foregoing anonymous communication establishing means as a notification target, from the foregoing notification control information storing means, and notifies the anonymity of at least one of the communication parties of the caller device and the callee device to the communication device to be designated by the designation information to be included in the above retrieved notification control information.

A ninth aspect of the present invention is characterized in, in the above-mentioned aspect, including a notification control information storing means for storing notification control information including designation information of the communication device, being a notification target, and notification conditions, wherein the foregoing anonymity notifying means retrieves the notification control information, which designates the communication device for performing the communication through the communication session to be established by the foregoing anonymous communication establishing means as a notification target, from the foregoing notification control information storing means, determines whether or not the notification condition to be included in the foregoing retrieved notification control information holds, and notifies the anonymity of at least one of the communication parties of the caller device and the callee device to the communication device to be designated by the designation information to be included in the foregoing retrieved notification control information when the notification condition holds.

A tenth aspect of the present invention is characterized in, in the above-mentioned aspect, including a notification control information storing means for storing notification control information including designation information of the communication device, being a notification target, and designation information of the communication party, being a notification target of the anonymity, wherein the foregoing anonymity notifying means retrieves the notification control information, which designates the communication device for performing the communication through the communication session to be established by the foregoing anonymous communication establishing means as a notification target, from the foregoing notification control information storing means, and notifies the anonymity of the communication party to be designated by the designation information of the communication party, being a notification target of the anonymity, that is included in the foregoing retrieved notification control information, out of the communication parties of the caller device and the callee device, to the communication device to be designated by the designation information to be included in the above retrieved notification control information.

An eleventh aspect of the present invention is characterized in, in the above-mentioned aspect, including a notification control information storing means for storing notification control information including designation information of the communication device, being a notification target, designation information of the communication party, being a notification target of the anonymity, and notification conditions, wherein the foregoing anonymity notifying means retrieves the notification control information, which designates the communication device for performing the communication through the communication session to be established by the foregoing anonymous communication establishing means as a notification target, from the foregoing notification control information storing means, determines whether or not the notification condition to be included in the foregoing retrieved notification control information holds, and notifies the anonymity of the communication party to be designated by the designation information of the communication party, being a notification target of the anonymity, that is included in the foregoing retrieved notification control information, out of the communication parties of the caller device and the callee device, to the communication device to be designated by the designation information to be included in the foregoing retrieved notification control information when the notification condition holds.

A twelfth aspect of the present invention, which is an anonymous communication method enabling a communication by anonymity, is characterized in detecting anonymities of communication parties during the communication subsequent to establishment of a communication session, and notifying them to the communication devices of the communication parties.

A thirteenth aspect of the present invention is characterized in; in the above-mentioned aspect, including: (a) an anonymous communication establishing step in which an anonymous communication establishing means acquires anonymity management information of a caller device and anonymity management information of a callee device from an anonymity managing means for retaining anonymity management information including a real address, an anonymous address and an anonymity of the communication device when having received a communication connection request designating the callee device from the caller device, establishes the communication session between the caller device and the callee device, and decides which address, out of the real address and the anonymous address, should be used as an address of the caller device to be notified to the callee device responding to the anonymity of the caller device to be included in the foregoing acquired anonymity management information; and (b) an anonymity notifying step in which an anonymity notifying means acquires the anonymity of at least one of the communication parties of the caller device and the callee device that are performing the communication through the communication session established by the foregoing anonymous communication establishing step from the foregoing anonymity management information, and notifies it to at least one communication device, out of the caller device and the callee device.

A fourteenth aspect of the present invention, which is an anonymity notifying apparatus to be installed in an anonymous communication system enabling a communication by anonymity, is characterized in detecting anonymities of communication parties during the communication subsequent to establishment of a communication session, and notifying them to communication devices of the communication parties.

A fifteenth aspect of the present invention, which is, in the above-mentioned aspect, an anonymity notifying apparatus to be installed in an anonymous communication system for including: an anonymity managing means for retaining anonymity management information including a real address, an anonymous address and the anonymity of the communication device; and an anonymous communication establishing means for acquiring the anonymity management information of a caller device and the anonymity management information of a callee device from the foregoing anonymity managing means when having received a communication connection request designating the callee device from the caller device, establishing the communication session between the caller device and the callee device, and deciding which address, out of the real address and the anonymous address, should be used as an address of the caller device to be notified to the callee device responding to the anonymity of the caller device to be included in the foregoing acquired anonymity management information is characterized in including a notifying means for acquiring the anonymity of at least one of the communication parties of the caller device and the callee device that are performing the communication through the communication session established by the foregoing anonymous communication establishing means from the foregoing anonymity management information, and notifying it to at least one communication device, out of the caller device and the callee device.

A sixteenth aspect of the present invention, which is a communication device in an anonymous communication system for including: an anonymity managing means for retaining anonymity management information including a real address, an anonymous address and an anonymity of a communication device; an anonymous communication establishing means for acquiring the anonymity management information of a caller device and the anonymity management information of a callee device from the foregoing anonymity managing means when having received a communication connection request designating the callee device from the caller device, establishing a communication session between the caller device and the callee device, and deciding which address, out of the real address and the anonymous address, should be used as an address of the caller device to be notified to the callee device responding to the anonymity of the caller device to be included in the foregoing acquired anonymity management information; and an anonymity notifying means for acquiring the anonymity of at least one of the communication parties of the caller device and the callee device that are performing the communication through the communication session established by the above anonymous communication establishing means from the foregoing anonymity management information, and notifying it to at least one communication device, out of the caller device and the callee device, is characterized in including a means for receiving the foregoing notification information to be notified from the foregoing anonymity notifying means, and outputting the anonymity to be shown by the foregoing notification information in one of a character output form, a voice output form, and a vibration output form, or a plurality of output forms.

A seventeenth aspect of the present invention causes a computer constituting an anonymity notifying apparatus to be installed in an anonymous communication system for including: an anonymity managing means for retaining anonymity management information including a real address, an anonymous address and an anonymity of a communication device; and an anonymous communication establishing means for acquiring the anonymity management information of a caller device and the anonymity management information of a callee device from the foregoing anonymity managing means when having received a communication connection request designating the callee device from the caller device, establishing a communication session between the caller device and the callee device, and deciding which address, out of the real address and the anonymous address, should be used as an address of the caller device to be notified to the callee device responding to the anonymity of the caller device to be included in the foregoing acquired anonymity management information to function as a notifying means for acquiring the anonymity of at least one of the communication parties of the caller device and the callee device that are performing the communication through the communication session established by the foregoing anonymous communication establishing means from the foregoing anonymity management information, and notifying it to at least one communication device, out of the caller device and the callee device.

An eighteen aspect of the present invention causes a computer constituting a communication device in an anonymous communication system for including: an anonymity managing means for retaining anonymity management information including a real address, an anonymous address and an anonymity of a communication device; an anonymous communication establishing means for acquiring the anonymity management information of a caller device and the anonymity management information of a callee device from the foregoing anonymity managing means when having received a communication connection request designating the callee device from the caller device, establishing a communication session between the caller device and the callee device, and deciding which address, out of the real address and the anonymous address, should be used as an address of the caller device to be notified to the callee device responding to the anonymity of the caller device to be included in the foregoing acquired anonymity management information; and an anonymity notifying means for acquiring the anonymity of at least one of the communication parties of the caller device and the callee device that are performing the communication through the communication session established by the above anonymous communication establishing means from the foregoing anonymity management information, and notifying it to at least one communication device, out of the caller device and the callee device, to function as a means for receiving the foregoing notification information to be notified from the foregoing anonymity notifying means, and outputting the anonymity to be shown by the foregoing notification information in one of a character output form, a voice output form, and a vibration output form, or a plurality of output forms.

Above, while the present invention has been particularly shown and described with reference to exemplary embodiments and exemplary, examples thereof, the present invention is not limited to the above mentioned exemplary embodiments and exemplary examples. It will be understood by those of ordinary skill in the art that various changes in form and details may be made therein without departing from the spirit and scope of the present invention as defined by the claims.

This application is based upon and claims the benefit of priority from Japanese patent application No. 2008-197945, filed on Jul. 31, 2008, the disclosure of which is incorporated herein in its entirety by reference.

### REFERENCE SIGNS LIST

100 and 200 anonymous communication systems

110 communication device

120 anonymity managing apparatus

130 anonymous communication establishing apparatus

140 anonymity notifying apparatus

150 network

1. An anonymous communication system enabling a communication by anonymity, said anonymous communication system detecting anonymities of communication parties during the communication subsequent to establishment of a communication session, and notifying them to communication devices of the communication parties.

2. An anonymous communication system according to claim 1, comprising:
an anonymity managing means for retaining anonymity management information including a real address, an anonymous address and an anonymity of the communication device;
an anonymous communication establishing means for acquiring the anonymity management information of a caller device and the anonymity management information of a callee device from said anonymity managing means when having received a communication connection request designating the callee device from the caller device, establishing the communication session between the caller device and the callee device, and deciding which address, out of the real address and the anonymous address, should be used as an address of the caller device to be notified to the callee device responding to the anonymity of the caller device to be included in said acquired anonymity management information; and
an anonymity notifying means for acquiring the anonymity of at least one of the communication parties of the caller device and the callee device that are making the communication through the communication session established by said anonymous communication establishing means from said anonymity management information, and notifying it to at least one communication device, out of the caller device and the callee device.

3. An anonymous communication system according to claim 2, comprising an caller/callee anonymity management information temporarily-preserving means for preserving said anonymity management information acquired by said anonymous communication establishing means during a period that the communication session established between the caller device and the callee device is active, wherein said anonymity notifying means acquires the anonymity of at least one of the communication parties of the caller device and the callee device, from said anonymity management information stored in said caller/callee anonymity management information temporarily-preserving means.

4. An anonymous communication system according to claim 2, wherein said anonymity notification means receives an anonymity notification request for requesting a notification of the anonymity of at least one device, out of the caller device and the callee device, from at least one device, out of the caller device and the callee device that are making the communication through the communication session established by said anonymous communication establishing means, acquires the anonymity requested by the above anonymity notification request from said anonymity management information, and notifies it to the communication device, being a requester.

5. An anonymous communication system according to claim 4:
wherein said anonymity notification request includes designation information of the communication device, being a requester, and notification conditions; and
wherein said anonymity notifying means detects an anonymous communication in which the communication device to be designated by said designation information of the communication device, being a requester, participates as the caller device or the callee device, out of the anonymous communications that are being made through the communication session to be established by said anonymous communication establishing means, determines whether or not the above detected anonymous communication satisfies the notification condition within said anonymity notification request, acquires the anonymity of at least one of the communication parties of the caller device and the callee device in said detected anonymous communication from said anonymity management information when it satisfies the notification condition, and notifies it to said communication device, being a requester.

6. An anonymous communication system according to claim 4:
wherein said anonymity notification request includes designation information of the communication device, being a requester, and designation information of the communication party, being a notification target of the anonymity; and
wherein said anonymity notifying means detects an anonymous communication in which the communication device to be designated by said designation information of the communication device, being a requester, participates as the caller device or the callee device, out of the anonymous communications that are being made through the communication session to be established by said anonymous communication establishing means, acquires the anonymity of the communication party to be designated by the designation information of the communication party, being a notification target of the anonymity, within said anonymity notification request, out of the communication parties of the caller device and the callee device in the above detected anonymous communication, from said anonymity management information, notifies it to said communication device, being a requester.

7. An anonymous communication system according to claim 4:
wherein said anonymity notification request includes designation information of the communication device, being a requester, designation information of the communication party, being a notification target of the anonymity, and notification conditions; and
wherein said anonymity notifying means detects an anonymous communication in which the communication device to be designated by said designation information of the communication device, being a requester, participates as the caller device or the callee device, out of the anonymous communications that are being made through the communication session to be established by said anonymous communication establishing means, determines whether or not the above detected anonymous communication satisfies the notification condition within said anonymity notification request, acquires the anonymity of the communication party to be designated by the designation information of the communication party, being a notification target of the anonymity, within said anonymity notification request, out of the communication parties of the caller device and the callee device in said detected anonymous communication, from said anonymity management information when it satisfies the notification condition, and notifies it to said communication device, being a requester.

8. An anonymous communication system according to claim 2, comprising a notification control information storing means for storing notification control information including designation information of the communication device, being a notification target, wherein said anonymity notifying means retrieves the notification control information, which designates the communication device for making the communication through the communication session to be established by said anonymous communication establishing means as a notification target, from said notification control information storing means, and notifies the anonymity of at least one of the communication parties of the caller device and the callee device to the communication device to be designated by the designation information to be included in the above retrieved notification control information.

9. An anonymous communication system according to claim 2, comprising a notification control information storing means for storing notification control information including designation information of the communication device, being a notification target, and notification conditions, wherein said anonymity notifying means retrieves the notification control information, which designates the communication device for making the communication through the communication session to be established by said anonymous communication establishing means as a notification target, from said notification control information storing means, determines whether or not the notification condition to be included in the above retrieved notification control information holds, and notifies the anonymity of at least one of the communication parties of the caller device and the callee device to the communication device to be designated by the designation information to be included in said retrieved notification control information when the notification condition holds.

10. An anonymous communication system according to claim 2, comprising a notification control information storing means for storing notification control information including designation information of the communication device, being a notification target, and designation information of the communication party, being a notification target of the anonymity, wherein said anonymity notifying means retrieves the notification control information, which designates the communication device for making the communication through the communication session to be established by said anonymous communication establishing means as a notification target, from said notification control information storing means, and notifies the anonymity of the communication party to be designated by the designation information of the communication party, being a notification target of the anonymity, that is included in said retrieved notification control information, out of the communication parties of the caller device and the callee device, to the communication device to be designated by the designation information to be included in the above retrieved notification control information.

11. An anonymous communication system according to claim 2, comprising a notification control information storing means for storing notification control information including designation information of the communication device, being a notification target, designation information of the communication party, being a notification target of the anonymity, and notification conditions, wherein said anonymity notifying means retrieves the notification control information, which designates the communication device for making the communication through the communication session to be established by said anonymous communication establishing means as a notification target, from said notification control information storing means, determines whether or not the notification condition to be included in said retrieved notification control information holds, and notifies the anonymity of the communication party to be designated by the designation information of the communication party, being a notification target of the anonymity, that is included in said retrieved notification control information, out of the communication parties of the caller device and the callee device, to the communication device to be designated by the designation information to be included in the above retrieved notification control information when the notification condition holds.

12. An anonymous communication method enabling a communication by anonymity, said anonymous communication method comprising detecting anonymities of communication parties during the communication subsequent to establishment of a communication session, and notifying them to the communication devices of the communication parties.

13. An anonymous communication method according to claim 12, comprising:
(a) an anonymous communication establishing step in which an anonymous communication establishing means acquires anonymity management information of a caller device and anonymity management information of a callee device from an anonymity managing means for retaining anonymity management information including a real address, an anonymous address and an anonymity of the communication device when having received a communication connection request designating the callee device from the caller device, establishes the communication session between the caller device and the callee device, and decides which address, out of the real address and the anonymous address, should be used as an address of the caller device to be notified to the callee device responding to the anonymity of the caller device to be included in said acquired anonymity management information; and
(b) an anonymity notifying step in which an anonymity notifying means acquires the anonymity of at least one of the communication parties of the caller device and the callee device that are making the communication through the communication session established by said anonymous communication establishing step from said anonymity management information, and notifies it to at least one communication device, out of the caller device and the callee device.

14. An anonymity notifying apparatus to be installed in an anonymous communication system enabling a communication by anonymity, said anonymity notifying apparatus detecting anonymities of communication parties during the communication subsequent to establishment of a communication session, and notifying them to communication devices of the communication parties.

15. An anonymity notifying apparatus according to claim 14 to be installed in an anonymous communication system for comprising: an anonymity managing means for retaining anonymity management information including a real address, an anonymous address and an anonymity of the communication device; and an anonymous communication establishing means for acquiring the anonymity management information of a caller device and the anonymity management information of a callee device from said anonymity managing means when having received a communication connection request designating the callee device from the caller device, establishing the communication session between the caller device and the callee device, and deciding which address, out of the real address and the anonymous address, should be used as an address of the caller device to be notified to the callee device responding to the anonymity of the caller device to be included in said acquired anonymity management information, said anonymity notifying apparatus comprising a notifying means for acquiring the anonymity of at least one of the communication parties of the caller device and the callee device that are making the communication through the communication session established by said anonymous communication establishing means from said anonymity management information and notifying it to at least one communication device, out of the caller device and the callee device.

16. A communication device in an anonymous communication system for including: an anonymity managing means for retaining anonymity management information including a real address, an anonymous address and an anonymity of a communication device; an anonymous communication establishing means for acquiring the anonymity management information of a caller device and the anonymity management information of a callee device from said anonymity managing means when having received a communication connection request designating the callee device from the caller device, establishing a communication session between the caller device and the callee device, and deciding which address, out of the real address and the anonymous address, should be used as an address of the caller device to be notified to the callee device responding to the anonymity of the caller device to be included in said acquired anonymity management information; and an anonymity notifying means for acquiring the anonymity of at least one of the communication parties of the caller device and the callee device that are making the communication through the communication session established by the above anonymous communication establishing means from said anonymity management information, and notifying it to at least one communication device, out of the caller device and the callee device, said communication device comprising a means for receiving said notification information to be notified from said anonymity notifying means, and outputting the anonymity to be shown by said notification information in one of a character output form, a voice output form, and a vibration output form, or a plurality of output forms.

17. A program for causing a computer constituting an anonymity notifying apparatus to be installed in an anonymous communication system for comprising: an anonymity managing means for retaining anonymity management information including a real address, an anonymous address and an anonymity of a communication device; and an anonymous communication establishing means for acquiring the anonymity management information of a caller device and the anonymity management information of a callee device from said anonymity managing means when having received a communication connection request designating the callee device from the caller device, establishing a communication session between the caller device and the callee device, and deciding which address, out of the real address and the anonymous address, should be used as an address of the caller device to be notified to the callee device responding to the anonymity of the caller device to be included said acquired anonymity management information to function as a notifying means for acquiring the anonymity of at least one of the communication parties of the caller device and the callee device that are making the communication through the communication session established by said anonymous communication establishing means from said anonymity management information, and notifying it to at least one communication device, out of the caller device and the callee device.

18. A program for causing a computer constituting a communication device in an anonymous communication system for comprising: an anonymity managing means for retaining anonymity management information including a real address, an anonymous address and an anonymity of a communication device; an anonymous communication establishing means for acquiring the anonymity management information of a caller device and the anonymity management information of a callee device from said anonymity managing means when having received a communication connection request designating the callee device from the caller device, establishing a communication session between the caller device and the callee device, and deciding which address, out of the real address and the anonymous address, should be used as an address of the caller device to be notified to the callee device responding to the anonymity of the caller device to be included in said acquired anonymity management information; and an anonymity notifying means for acquiring the anonymity of at least one of the communication parties of the caller device and the callee device that are making the communication through the communication session established by the above anonymous communication establishing means from said anonymity management information, and notifying it to at least one communication device, out of the caller device and the callee device, to function as a means for receiving said notification information to be notified from said anonymity notifying means, and outputting the anonymity to be shown by said notification information in one of a character output form, a voice output form, and a vibration output form, or a plurality of output forms.
